(19) United States
(12) Patent Application Publication
(10) Pub. No.: US 2013/0270257 A1
(43) Pub. Date: Oct. 17, 2013

(54) EXHAUST SENSOR HEATER CIRCUIT FOR NON-CALIBRATED REPLACEMENT IN EXISTING APPLICATIONS

(71) Applicants: Debabrata Sarkar, Rochester, MI (US); Walter Thomas Symons, Grand Blanc, MI (US); Eric P. Clyde, Metamora, MI (US); David E. Lemaster, White Lake, MI (US); Gerardo I. Hernandez, Torreon (MX)

(72) Inventors: Debabrata Sarkar, Rochester, MI (US); Walter Thomas Symons, Grand Blanc, MI (US); Eric P. Clyde, Metamora, MI (US); David E. Lemaster, White Lake, MI (US); Gerardo I. Hernandez, Torreon (MX)

(73) Assignee: DELPHI TECHNOLOGIES, INC., TROY, MI (US)

(21) Appl. No.: 13/701,728

(22) PCT Filed: Jun. 6, 2011
(86) PCT No.: PCT/US11/39235

§ 371 Date: Jun. 17, 2013

Related U.S. Application Data
(60) Provisional application No. 61/351,348, filed on Jun. 4, 2010.
(60) Provisional application No. 61/351,396, filed on Jun. 4, 2010.

(51) Int. Cl. H05B 1/00

(52) U.S. Cl. CPC H05B 1/00
USPC 219/553

(57) ABSTRACT

A planar device includes a heating circuit that is disposed between ceramic layers in a planar device and co-fired with the ceramic. The heating circuit material and geometry are controlled so as to provide a targeted resistance characteristic as a function of temperature that allows interchangeability in an engine management system that was designed for a heater circuit based on a material system that cannot be co-fired with the planar device.

### CROSS REFERENCE TO RELATED APPLICATIONS

This application claims priority to U.S. Provisional Application Ser. No. 61/351,348, filed Jun. 4, 2010, the contents of which are hereby incorporated by reference. This application additionally claims priority to U.S. Provisional Application Ser. No. 61/351,396, filed Jun. 4, 2010, the contents of which are hereby incorporated by reference.

### TECHNICAL FIELD

The present disclosure relates to a heating circuit in a co-fired planar oxygen sensor that can be used to replace an oxygen sensor in existing applications without requiring vehicle recalibration.

### BACKGROUND OF THE INVENTION

Current planar oxygen sensors use ceramic tapes and appropriate metallizations to form a sensor structure. Tapes (ceramic substrates) include insulating materials (alumina or zirconia) and an electrolyte (zirconia) in addition to metallizations to form functional Nernst cell exhaust sensors. Such planar devices are formed as multi-layer co-fired ceramic circuits, where all components are assembled in “green” (unfired) state, laminated to form a contiguous structure, and co-fired at temperatures appropriate for densification of ceramic body and formation of a monolithic structure after sintering. Due to the high sintering temperatures required for the ceramic substrates (1400°-1600° C.), metallization is limited to PGM (Platinum Group Metals) materials. Exhaust Oxygen sensors typically use platinum for the heater circuit in the co-fired device. Platinum has a TCR (Temperature Coefficient of Resistance) of around 3850 ppm/K. This gives Pt heater circuits a very specific electrical signature.

Previous oxygen sensor technologies utilized conical (thimble) elements with a separate heating element comprised of a tungsten alloy co-fired with an alumina ceramic. Zirconia and tungsten cannot be co-fired. The high-temperature oxidation characteristics of tungsten dictate that a reducing atmosphere is required for sintering. However, zirconia requires an oxidizing atmosphere to prevent reduction of the oxide to its metallic form and so tungsten is not a good choice for co-firing with zirconia.

As conical exhaust sensors go out of regular production, a market has emerged for replacement sensors. EMS (Engine Management System) diagnostics and heater controls for conical sensors in many applications depend on the TCR of the heater circuit for proper function, as the system controls are based on heater resistance at operating temperature. For a consistent sensor performance, many applications measure the heater current during a cold start after 8 hours or more soaking time. From the heater current measure, the resistance of the heater can be calculated since the current and voltage supply is known (Ohm's Law). Based on the cold heater resistance, the heater duty cycle is controlled for a high or low heater resistance to maintain a desire element tip temperature. The TCR of the tungsten alloy used in heaters for conical exhaust sensors is much lower than the TCR of the platinum typically used in planar oxygen sensors, making it difficult for a co-fired planar sensor to match the electrical characteristics of a conical sensor sufficiently closely to enable direct replacement without reprogramming the EMS.

Accordingly, a need exists in the sensor art for a co-fired planar exhaust oxygen sensor that can replicate the characteristics of a conical exhaust oxygen sensor.

### SUMMARY

Disclosed herein is a heater circuit for a co-fired planar exhaust sensor that matches the characteristics of a conical exhaust sensor. The heater circuit alloy and the heater circuit geometry are both controlled to achieve a target effective base resistance and effective TCR. The heater circuit is sufficiently matched to the base resistance and TCR of a tungsten alloy heater used with a conical sensor such that an EMS that is calibrated to the characteristics of the tungsten alloy heater can operate with the co-fired planar exhaust sensor with no recalibration.

The above described and other features are exemplified by the following figures and detailed description.

### BRIEF DESCRIPTION OF THE DRAWINGS

Refer now to the Figures, wherein like elements are numbered alike.

FIG. 1 is a plan view of a heater circuit in a planar device.

FIG. 2 is a plot showing the temperature profile over a heater circuit.

FIG. 3 is an equivalent electrical circuit for a heater circuit.

### DETAILED DESCRIPTION

At the outset of the description, it should be noted that the terms “first,” “second,” and the like, herein do not denote any order, quantity, or importance, but rather are used to distinguish one element from another, and the terms “a” and “an” herein do not denote a limitation of quantity, but rather denote the presence of at least one of the referenced items. The modifier “about” used in connection with a quantity is inclusive of the stated value and has the meaning dictated by the context (e.g., includes the degree of error associated with measurement of the particular quantity). It is noted that the terms “bottom” and “top” are used herein, unless otherwise noted, merely for convenience of description, and are not limited to any one position or spatial orientation. Furthermore, all ranges disclosed herein are inclusive and combinable (e.g., ranges of “up to about 25 weight percent (wt. %), with about 5 wt. % to about 20 wt. % desired, and about 10 wt. % to about 15 wt. % more desired,” are inclusive of the endpoints and all intermediate values of the ranges, e.g., “about 5 wt. % to about 25 wt. %, about 5 wt. % to about 15 wt. %”, etc.). Finally, unless defined otherwise, technical and scientific terms used herein have the same meaning as is commonly understood by one of skill in the art to which this invention belongs. The suffix “(s)” as used herein is intended to include both the singular and the plural of the term that it modifies, thereby including one or more of that term (e.g., the metal(s) includes one or more metals).

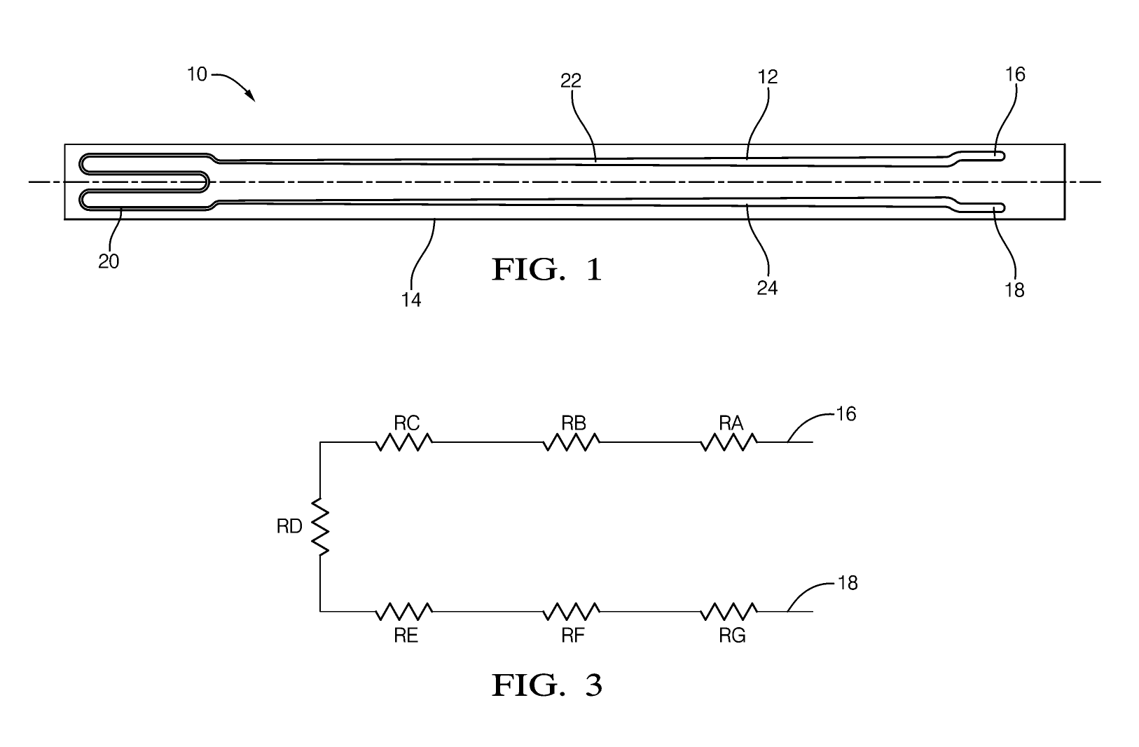

An exemplary heater 10 as used in a planar oxygen-sensing element is shown in FIG. 1. The sensor comprises an electrically conductive material disposed on a substrate 14 in a heater circuit 12. The heater circuit 12 shown in FIG. 1 includes a first contact pad 16 connected to one end of a first lead 22. The other end of the lead 22 connects to one end of a serpentine pattern 20. The other end of the serpentine pattern 20 connects to a first end of a second lead 24. The other end of the second lead 24 connects to a second contact pad 18. It will be appreciated that the first contact pad 16, first lead 22, serpentine pattern 20, second lead 24, and second contact pad 18 are not required to be distinct elements, but rather may refer to segments of a single continuous element. It will also be appreciated that reference to first or second ends of a segment refers to a location where an electrical connection is made and is not limited to a location that is spatially opposite another location on the segment.

The heater circuit 12 is operated by connecting a source of electric power to contact pads 16 and 18. It will be appreciated that the electrically conductive material has an associated electrical resistance, which is a function of the resistivity of the material and of the geometry of the heater circuit. As electrical current passes through the heater circuit 12, power is dissipated in the heater circuit through resistive heating according to the relationship P=I²R, where P is the power, I is the current, and R is the resistance. This power dissipation becomes thermal energy, raising the temperature of the heater and any other elements that are in thermal communication with the heater. The heater circuit 12 is designed such that a desired temperature distribution is obtained. In an exemplary embodiment, serpentine pattern 20 is located close to the electrochemical cell. The exemplary heater circuit 12 is designed so that the maximum heating is achieved in the vicinity of serpentine pattern 20. In such a way, the heater can be used to heat the electrochemical cell in an exhaust oxygen sensor to a temperature required by the electrochemical cell to produce a usable output voltage.

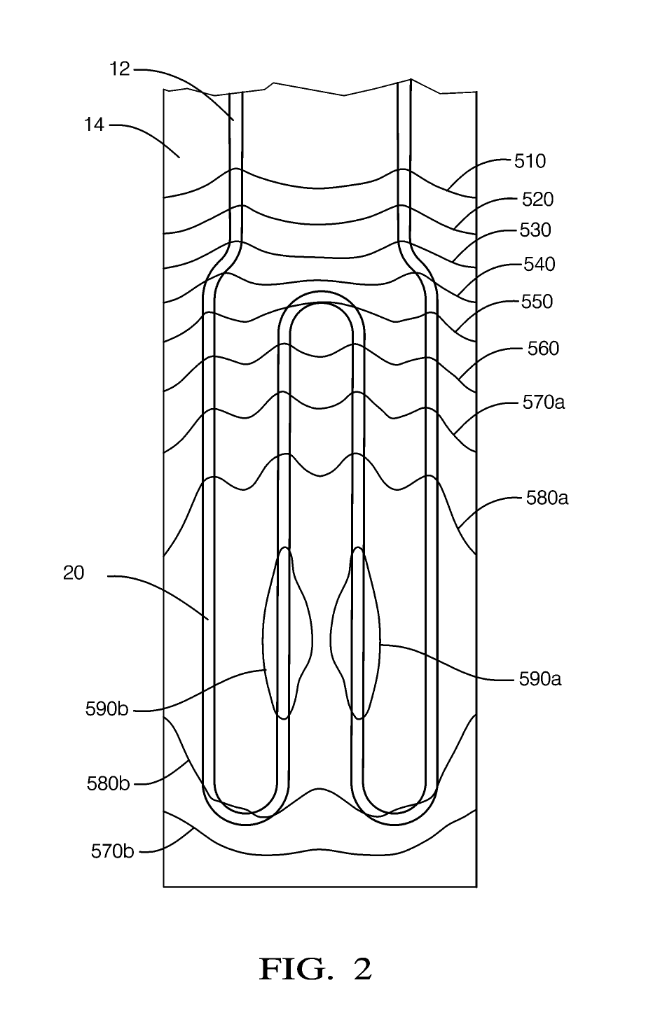

It will be appreciated that heat will be produced as a result of current flow at each incremental segment of heater circuit 12, and that the sum of the heat contributions of each incremental segment will contribute to an overall temperature profile over the entire substrate area. FIG. 2 illustrates an exemplary temperature profile at the end of substrate 14 where the serpentine pattern 20 of heater circuit 12 is located, indicating temperatures obtained by passing a particular level of current through the heater circuit 12 shown in FIG. 1 at a particular ambient temperature. In FIG. 2, points lying along the line marked 510 indicate the locations on substrate 14 where the temperature is 510° C. Similarly, line 520 on FIG. 2 indicates points having a temperature of 520° C., line 530 on FIG. 2 indicates points having a temperature of 530° C., line 540 indicates points that are at a temperature of 540° C., line 550 indicates points at 550° C., lines 570a and 570b indicate points that are at 570° C., lines 580a and 580b indicate points that are at 580° C., and lines 590a and 590b indicate points that are at 590° C. The actual thermal profile for a heater circuit depends on many factors, including the ambient temperature, the material used to form the heater circuit, the voltage level applied to the heater circuit, and the geometry of the conductor pattern that defines the heater circuit.

In addition to having an associated resistivity, the electrically conductive material has an associated temperature coefficient of resistivity (TCR). The TCR of a material is commonly referred to as alpha (a), and the resistance of a resistive element at a temperature T can be described as R(T)=R₀(1+α(T−T₀)), where T is the temperature at which the resistance R(T) is measured and R₀ is the resistance of the resistive element at a reference temperature T₀. Metals typically have a positive TCR, meaning that the resistance increases with increasing temperature. To provide a heater circuit that can be used to replace a tungsten alloy heater used in earlier generation conical oxygen sensor without requiring engine management system recalibration, a palladium-rhodium alloy was found to provide a compatible TCR. More particularly, to achieve the targeted characteristics in an exemplary embodiment, an alloy comprising about 95% palladium and 5% rhodium was found to be suitable.

FIG. 3 shows a simplified electrical schematic equivalent circuit for the heater circuit in FIG. 1. In FIG. 3, heater circuit 12 is modeled as having seven resistive segments RA, RB, RC, RD, RE, RF, and RG connected electrically in series between the first contact pad 16 and the second contact pad 18. It is to be noted that the choice of seven segments is merely for convenience, and is in no way to be construed as limiting.

The total resistance indicated between contact pads 16 and 18 is the sum of the individual resistances. For the example depicted in FIG. 3,

Rtotal=RA+RB+RC+RD+RE+RF+RG

It must be noted that each resistive segment that comprises the total resistance has an associated TCR, and is operating at its own associated temperature as depicted in FIG. 2. Assuming the TCR has the same value a for each resistive segment, the resistance of each segment can be determined as:

RA=RA₀(1+α(T_{A}-T₀))

RB=RB₀(1+α(T_{B}-T₀))

RC=RC₀(1+α(T_{C}-T₀))

RD=RD₀(1+α(T_{D}-T₀))

RE=RE₀(1+α(T_{E}-T₀))

RF=RF₀(1+α(T_{F}-T₀))

RG=RG₀(1+α(T_{G}-T₀))

where:
RA₀ is the resistance of RA at a temperature T₀, and T_{A} is the temperature of RA;
RB₀ is the resistance of RB at a temperature T₀, and T_{B} is the temperature of RB;
RC₀ is the resistance of RC at a temperature T₀, and T_{C} is the temperature of RC;
RD₀ is the resistance of RD at a temperature T₀, and T_{D} is the temperature of RD;
RE₀ is the resistance of RE at a temperature T₀, and T_{E} is the temperature of RE;
RF₀ is the resistance of RF at a temperature T₀, and T_{F} is the temperature of RF;
RG₀ is the resistance of RG at a temperature T₀, and T_{G} is the temperature of RG.

If the temperature at the locations of each of the resistive segments are known (for example by knowing a temperature profile as exemplified in FIG. 2), the total resistance can be determined by performing the calculations indicated in the foregoing equations. It will be appreciated that actual analysis may involve fewer or more resistive segments than the seven segments shown in the illustrative example of FIG. 3.

It is known to one skilled in the art that the electrical resistance of a resistive element is given by the relationship R=ρL/A, where the bulk resistivity ρ is a material property of the resistive material, L is the length of the resistive element in the direction of current flow, and A is the cross sectional area of the resistive element perpendicular to the direction of current flow. To achieve a heater circuit characteristic that allows replacement of a tungsten alloy heater circuit, it will be appreciated that the resistance of each segment that forms a heater circuit can be adjusted so that the sum of the resistances, each of which is at its own distinct temperature, produces a targeted total resistance when measured between contact pad 16 and contact pad 18. The resistance of a resistive segment can be changed by changing its length and/or by changing its cross sectional area. Changing the cross sectional area can be achieved by changing the thickness and/or the width of the resistive segment. In the exemplary embodiment shown in FIG. 1, it can be seen that the width of lead segment 22 and lead segment 24 are each tapered from a narrow width near the serpentine segment 20 to a wider width near the contact pads 16, 18 to achieve a desired heater circuit characteristic.

It will also be appreciated that the temperature of a given resistive segment may be influenced by the resistance of the segment, as the electrical power that is converted to heat is related to the resistance by the relationship P=I²R, where P is the power in watts, I is the current in amperes, and R is the resistance in ohms. It is to be noted that the resistance depends on the temperature (because of TCR effects), the temperature depends on the power dissipation (because of the conversion of electrical energy to thermal energy), and the power dissipation depends on the resistance (because of the relationship between power, current, and resistance). Accordingly, an iterative process may be required to produce a heater circuit having a desired total resistance when measured between the contact pads 16, 18 at a given level of heater drive voltage or current.

An engine management system may be programmed to perform diagnosis of the proper condition of a heater circuit. Diagnosis may include providing a predetermined voltage to the heater circuit and measuring the current flowing through the heater circuit to determine the resistance of the heater circuit. It will be appreciated that the resistance of the heater circuit is not a constant value, but is dependent on the temperature of the resistive material that is included in the heater circuit. An engine management system may be calibrated based on characteristics of a particular heater circuit, where the characteristics include a particular heater circuit material and a particular heater circuit geometry. The engine management system may provide a predetermined voltage to a heater circuit and provide indication of a heater circuit fault if the current flow resulting from the application of the predetermined voltage does not fall within predetermined limits. The present invention provides a heater circuit that can be used as a drop-in replacement in an engine management system without necessitating recalibration of the engine management system diagnostic characteristics by matching the electrical characteristics of a particular heater circuit (e.g. a tungsten rod heater in a conical oxygen sensor) by controlling the composition (e.g. palladium rhodium alloy) and geometry (e.g. cross sectional area as a function of location on the substrate) of a heater circuit in a planar sensor.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation of material to the teachings of the invention without departing from the essential scope thereof. Therefore, it is intended that the invention not be limited to the particular embodiments disclosed as including the best mode contemplated for carrying out this invention, but that the invention will include all embodiments falling within the scope of the appended claims.

What is claimed is:

1. A heater circuit in a co-fired planar sensor, the heater circuit comprising an electrically conductive material having a resistivity and a temperature coefficient of resistivity, the electrically conductive material disposed on a planar substrate to form a continuous conductive path between a first contact pad and a second contact pad;
wherein when electric current is passed through the conductive path, resistive heating induces a temperature rise in the electrically conductive material;
wherein the electrically conductive material is thermally coupled to the substrate such that the temperature rise in the electrically conductive material induces a temperature rise in the substrate, the temperature rise of a point on the substrate being dependent on the location of the point on the substrate to create a temperature profile;
wherein the cross sectional area of the conductive path taken perpendicular to the direction of current flow varies in a predetermined manner along the length of the conductive path in the direction of current flow such that the temperature profile that is created as a function of location on the substrate raises the temperature of each point along the conductive path such that the overall resistance and temperature coefficient of resistance of the heater circuit measured between the first contact pad and the second contact pad are effective to emulate a predetermined resistance and a predetermined temperature coefficient of resistance for the heater circuit.

2. The heater circuit in claim 1, wherein the electrically conductive material is a palladium-rhodium alloy.

3. The heater circuit in claim 1, wherein the predetermined resistance and the predetermined temperature coefficient of resistance are based on the characteristics of a heater comprising a tungsten alloy.

4. The heater circuit in claim 1 wherein the planar sensor is an exhaust oxygen sensor and the sensor is co-fired in an oxidizing atmosphere.

5. The heater circuit in claim 1 wherein the first contact pad and second contact pad are located toward a first end of the substrate, and the conductive path is configured so as to taper from a relatively wide width proximate the first contact pad and second contact pad to a relatively narrow width remote from the first contact pad and second contact pad.
